(19) United States
(12) Patent Application Publication
(10) Pub. No.: US 2015/0014900 A1
(43) Pub. Date: Jan. 15, 2015

(54) COMPOSITE CONDUCTIVE POWDER, CONDUCTIVE PASTE FOR EXTERNAL ELECTRODE INCLUDING THE SAME, AND MANUFACTURING METHOD OF MULTILAYER CERAMIC CAPACITOR

(71) Applicant: SAMSUNG ELECTRO-MECHANICS CO., LTD., Suwon (KR)

(72) Inventors: Kyu Ha LEE, Suwon (KR); Seung Hee YOO, Suwon (KR); Byung Jun JEON, Suwon (KR); Eun Joo CHOI, Suwon (KR); Hee Sang KANG, Suwon (KR); Chang Joo LEE, Suwon (KR)

(73) Assignee: SAMSUNG ELECTRO-MECHANICS CO., LTD., Suwon (KR)

(21) Appl. No.: 14/060,412

(22) Filed: Oct. 22, 2013

(30) Foreign Application Priority Data
Jul. 12, 2013 (KR) 10-2013-0082036

(51) Int. Cl. H01G 4/005; H01G 4/008

(52) U.S. Cl. CPC H01G 4/005; H01G 4/008
USPC 264/615; 252/500

(57) ABSTRACT

There is provided a composite conductive powder including a conductive particle, and a coating layer formed on a surface of the conductive particle and including glass, wherein when a thickness of the coating layer in a portion A in which the coating layer is the thickest, on the surface of the conductive particle is defined as a, and a thickness of the coating layer in a portion B forming an angle of 90° with respect to the portion A on the surface of the conductive particle, based on a center of the conductive particle is defined as b, 0.1≦b/a≦0.7 is satisfied.

### CROSS-REFERENCE TO RELATED APPLICATIONS

This application claims the benefit of Korean Patent Application No. 10-2013-0082036 filed on Jul. 12, 2013, with the Korean Intellectual Property Office, the disclosure of which is incorporated herein by reference.

### BACKGROUND OF THE INVENTION

1. Field of the Invention

The present invention relates to a composite conductive powder, a conductive paste for an external electrode including the same, and a manufacturing method of a multilayer ceramic capacitor using the conductive paste for an external electrode.

2. Description of the Related Art

Generally, electronic components using a ceramic material, such as a capacitor, an inductor, a piezoelectric element, a varistor, a thermistor, or the like, include a ceramic body made of a ceramic material, internal electrodes formed in the ceramic body, and external electrodes mounted on external surfaces of the ceramic body so as to be connected to the internal electrodes.

Among ceramic electronic components, a multilayer ceramic capacitor includes a plurality of stacked dielectric layers, internal electrodes disposed to face each other, having the dielectric layer interposed therebetween, and external electrodes electrically connected to the internal electrodes.

Multilayer ceramic capacitors have been widely used as components in mobile communications devices such as laptop computers, personal digital assistants (PDAs), mobile phones, and the like, due to advantages thereof such as a small size, high capacitance, ease of mounting, or the like.

In accordance with the recent trend toward maltifunctionalization and miniaturization of electronic devices, chip components also tend to be miniaturized and multifunctionalized. Therefore, demands have been made for multilayer ceramic capacitors having a small size and high capacitance.

In this case, a method of miniaturizing a multilayer ceramic capacitor and increasing capacitance thereof by decreasing a thickness of an external electrode layer, while maintaining an overall size of a chip has been attempted.

However, when the external electrode layer is thin, electrode compactness or corner coverage may be relatively reduced and defects such as blisters, delamination defects of external electrodes, and the like, may be generated to cause deterioration in reliability of the multilayer ceramic capacitor.

### RELATED ART DOCUMENT

(Patent Document 1) Korean Patent Laid-Open Publication No. 10-2006-0045129

### SUMMARY OF THE INVENTION

An aspect of the present invention provides a composite conductive powder, a conductive paste for an external electrode including the same, and a manufacturing method of a multilayer ceramic capacitor using the conductive paste for an external electrode.

According to an aspect of the present invention, there is provided a composite conductive powder including: a conductive particle; and a coating layer formed on a surface of the conductive particle and including glass, wherein when a thickness of the coating layer in a portion A in which the coating layer is the thickest, on the surface of the conductive particle is defined as a, and a thickness of the coating layer in a portion B forming an angle of 90° with respect to the portion A on the surface of the conductive particle, based on a center of the conductive particle is defined as b, 0.1≦b/a≦0.7 is satisfied.

When a diameter of the conductive particle is defined as d, a/d<0.2 may be satisfied.

The thickness of the coating layer may be gradually increased from a portion in which the coating layer is thinnest to the portion A in which the coating layer is the thickest, on the surface of the conductive particle.

The glass may be included in an amount of 1 to 20 parts by weight based on 100 parts by weight of the conductive particle.

The glass may have a density of 1.5 g/cc to 5.0 g/cc.

The conductive particle may have an average particle diameter of 0.5 to 2.0 μm.

The conductive particle may have a spherical shape.

According to another aspect of the present invention, there is provided a conductive paste for an external electrode, conductive paste including: a conductive particle; and a coating layer formed on a surface of the conductive particle and including glass, wherein when a thickness of the coating layer in a portion A in which the coating layer is the thickest, on the surface of the conductive particle is defined as a, and a thickness of the coating layer in a portion B forming an angle of 90° with respect to the portion A on the surface of the conductive particle, based on a center of the conductive particle is defined as b, 0.1≦b/a≦0.7 is satisfied.

According to another aspect of the present invention, there is provided a manufacturing method of a multilayer ceramic capacitor, the manufacturing method including: preparing a plurality of ceramic green sheets; forming internal electrode patterns on the ceramic green sheets; stacking the ceramic green sheets including the internal electrode patterns formed thereon to form a ceramic laminate; firing the ceramic laminate to form a ceramic body; applying a conductive paste for an external electrode to the ceramic body to be electrically connected to internal electrodes; and sintering the conductive paste for an external electrode to form an external electrode, wherein the conductive paste for an external electrode may include a conductive particle and a coating layer formed on a surface of the conductive particle and including glass, and when a thickness of the coating layer in a portion A in which the coating layer is the thickest, on the surface of the conductive particle is defined as a, and a thickness of the coating layer in a portion B forming an angle of 90° with respect to the portion A on the surface of the conductive particle, based on a center of the conductive particle is defined as b, 0.1≦b/a≦0.7 is satisfied.

The sintering of the conductive paste for an external electrode may be performed at 600 to 800° C.

When a diameter of the conductive particle is defined as d, a/d<0.2 may be satisfied.

The thickness of the coating layer may be gradually increased from a portion in which the coating layer is thinnest to the portion A in which the coating layer is the thickest, on the surface of the conductive particle.

The glass may be included in an amount of 1 to 20 parts by weight based on 100 parts by weight of the conductive particle.

The glass may have a density of 1.5 g/cc to 5.0 g/cc.

The conductive particle may have an average particle diameter of 0.5 to 2.0 μm.

The conductive particle may have a spherical shape.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cutaway perspective view of a composite conductive powder according to an embodiment of the present invention;

FIG. 2 is a cross-sectional view of the composite conductive powder, taken along line C-C′ of FIG. 1;

FIG. 3 is a scanning electron microscope (SEM) photograph showing a cross-section of the composite conductive powder according to the embodiment of the present invention;

FIG. 4A is a scanning electron microscope (SEM) photograph showing the composite conductive powder according to the embodiment of the present invention, and FIG. 4B is a scanning electron microscope (SEM) photograph showing a conductive powder and a glass powder according to Comparative Example;

FIG. 5 is a flow chart showing a manufacturing method of a multilayer ceramic capacitor according to an embodiment of the present invention;

FIG. 6 is a schematic perspective view of the multilayer ceramic capacitor manufactured according to the embodiment of the present invention;

FIG. 7 is a cross-sectional view of the multilayer ceramic capacitor, taken along line P-P′ of FIG. 6;

FIG. 8A is a photograph showing a surface of an external electrode of the multilayer ceramic capacitor manufactured according to Example of the present invention, and FIG. 8B is a photograph showing a surface of an external electrode of a multilayer ceramic capacitor according to Comparative Example;

FIGS. 9A and 9B are photographs showing enlarged surfaces of the external electrodes of FIGS. 8A and 8B, respectively; and

FIG. 10A is a photograph showing a cross-section of the external electrode of the multilayer ceramic capacitor manufactured according to Example of the present invention, and FIG. 10B is a photograph showing a cross-section of the external electrode of the multilayer ceramic capacitor according to the Comparative Example.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

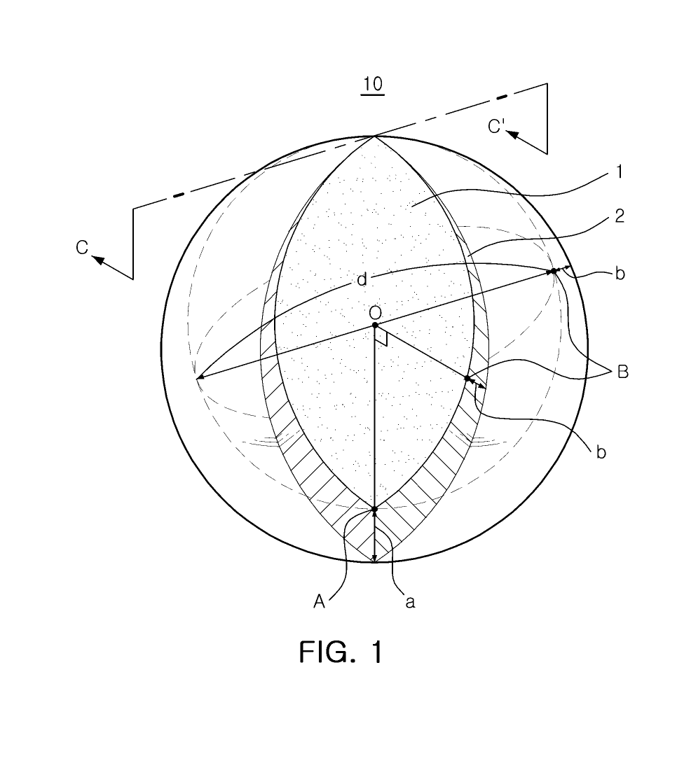

FIG. 1 is a partially cutaway perspective view of a composite conductive powder according to an embodiment of the present invention.

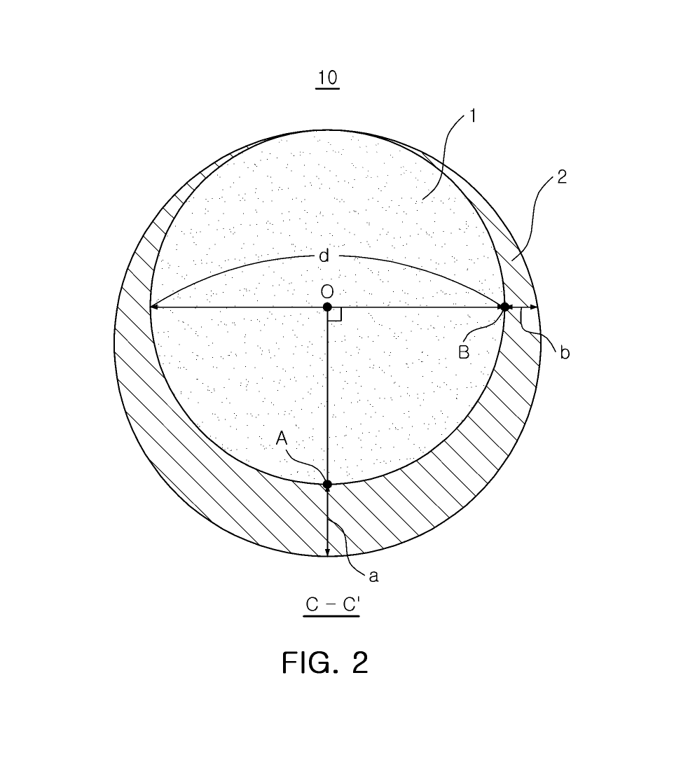

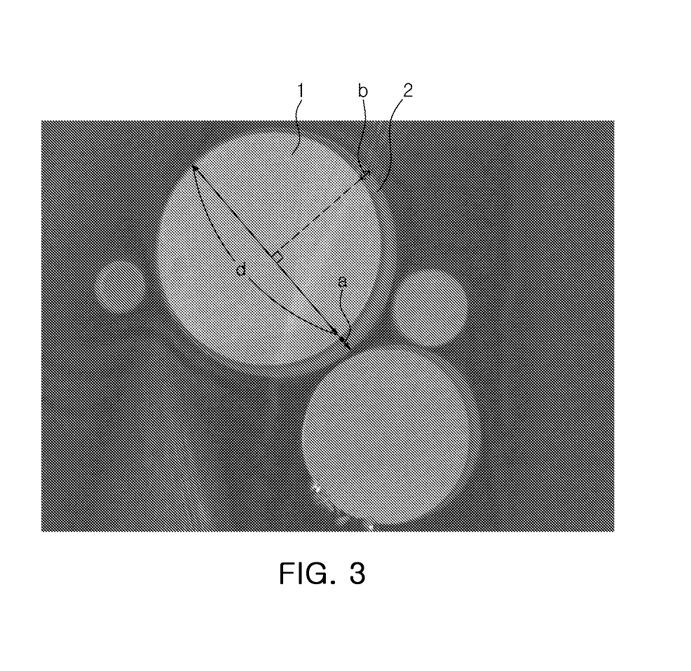

FIG. 2 is a cross-sectional view of the composite conductive powder, taken along line C-C′ of FIG. 1, and FIG. 3 is a scanning electron microscope (SEM) photograph showing a cross-section of the composite conductive powder according to the embodiment of the present invention.

Referring to FIGS. 1 through 3, a composite conductive powder 10 according to the embodiment of the present invention may include a conductive particle 1; and a coating layer 2 formed by coating a surface of the conductive particle 1 with glass.

The conductive particle 1 is not particularly limited as long as it may be applied to an external electrode and has conductivity. For example, the conductive particle may be formed of at least one selected from a group consisting of copper (Cu), silver (Ag), nickel (Ni), and an alloy thereof.

A particle size of the conductive particle 1 may be variously provided according to objects of the present invention. For example, the conductive particle 1 may have an average particle diameter of 0.5 to 2.0 μm. In addition, the conductive particle may be a spherical particle.

The coating layer 2 may be formed by coating the surface of the conductive particle 1 with glass.

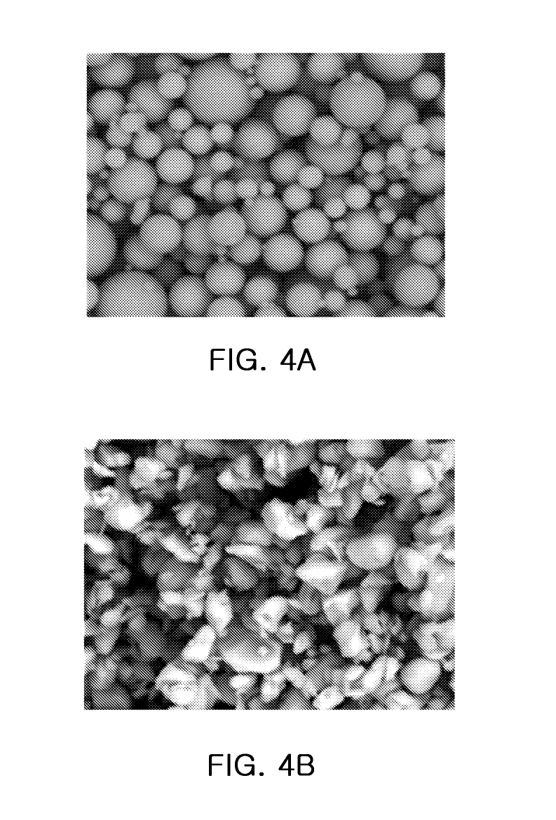

FIG. 4A is a scanning electron microscope (SEM) photograph showing the composite conductive powder according to the embodiment of the present invention, and FIG. 4B is a scanning electron microscope (SEM) photograph showing a conductive powder and a glass powder according to Comparative Example.

An external electrode of a multilayer ceramic capacitor may be manufactured using a conductive paste. Generally, a paste for an external electrode may be prepared by mixing a conductive powder, a glass frit, a base resin, an organic vehicle, or the like, together. The glass frit, a component of the paste, may be mixed in the form of a particle having a non-uniform shape, a particle size of which may be 1.0 to 3.0 μm, as illustrated in FIG. 4B.

However, according to the present invention, glass may be coated on the surface of the conductive particle, such that glass components may be uniformly dispersed in a paste as shown in FIG. 4A. Thus, in the case of forming an external electrode, compactness of the external electrode may be improved.

A thickness of the coating layer may be varied. That is, the coating layer 2 formed on the surface of the conductive particle 1 does not have a uniform thickness and may be reduced at a specific portion of the surface and be increased at the other portion thereof.

In addition, the thickness of the coating layer 2 may be gradually varied from the maximum thickness thereof to the minimum thickness thereof. That is, the coating layer may be gradually increased from a portion in which the coating layer is thinnest to a portion in which the coating layer is the thickest, on the surface of the conductive particle.

In other words, in a view of the cross-section of the composite conductive powder 10, cut to pass through the center of the conductive particle 1, the composite conductive powder 10 may be formed such that the conductive particle 1 is not present in the center of the coating layer 2 but may be biased to one side.

However, in the case in which the coating layer is formed to have a uniform thickness, the external electrode and an internal electrode may not be suitably bonded to each other during a firing process of the external electrode, or conductivity of the external electrode may be deteriorated.

However, in the case in which the coating layer is formed to have a uniform thickness and a thickest coating portion thereof and a thinnest coating portion thereof are formed on a single conductive particle according to the embodiment of the present invention, the conductive particle may be exposed through a portion thereof on which the thinnest coating portion is formed during the firing process, such that an alloy of the conductive particle and a metal contained in the internal electrode may be formed, and connectivity between the conductive particles contained in the external electrode may be secured.

Particularly, when a thickness of the coating layer in a portion A in which the coating layer is the thickest, on the surface of the conductive particle is defined as a, and a thickness of the coating layer in a portion B forming an angle of 90° with respect to the portion A on the surface of the conductive particle, based on the center of the conductive particle is defined as b, the coating layer may satisfy 0.1≦b/a≦0.7.

In the case in which b/a is less than 0.1, it may be difficult to control an amount of glass to be coated. At the time of forming the conductive paste for an external electrode using a composite conductive powder in which b/a is less than 0.1, glass components contained in the conductive paste for an external electrode may be non-uniformly distributed. In the case in which the glass components in the conductive paste for an external electrode may be non-uniformly distributed, compactness of the external electrode may be deteriorated, and beading and blisters of glass may be generated.

Further, in the case in which b/a is greater than 0.7, connectivity between the internal electrode and the external electrode may not be secured, such that capacitance may be decreased, or conductivity of the external electrode may be deteriorated.

Further, when a diameter of the conductive particle is defined as d, and the thickness of the coating layer in the portion A in which the coating layer is the thickest is defined as a, the conductive particle and the coating layer may be formed such that a/d<0.2 is satisfied.

In the case in which a/d is 0.2 or greater, the coating layer may be excessively thick, such that it may be difficult to manufacture the coating layer having a thick region and a thin region.

A density of the glass contained in the coating layer may be appropriately changed according to usages and may be 1.5 g/cc to 5.0 g/cc, but is not limited thereto.

In the case in which the density of the glass contained in the coating layer is less than 1.5 g/cc, it may be difficult to control a constant amount of glass coated on the surface of the conductive particle due to a high degree of volume ratio per unit weight, thereby causing dispersion in properties of the conductive paste for an external electrode. In addition, at the time of forming the external electrode, defects such as a decrease in the compactness of the external electrode, blisters, and the like, may be generated. Further, in the case in which the density of the glass contained in the coating layer is greater than 5.0 g/cc, a content of silicon (Si) or boron (B) in the glass is rapidly decreased, such that at the time of forming a plating layer on the external electrode to be later, acid resistance thereof against a nickel (Ni) or tin (Sn) plating solution may be reduced due to the decrease in the content of silicon (Si) or boron (B), a main component of a glass network structure, thereby deteriorating reliability of the multilayer ceramic capacitor.

In addition, the glass may be included in an amount of 1 to 20 parts by weight based on 100 parts by weight of the conductive particle.

In the case in which the glass is included in an amount greater than 20 parts by weight based on 100 parts by weight of the conductive particle, the external electrode may be excessively rapidly sintered, thereby causing defects such as blisters and glass beading. Further, a formation of an alloy of a conductive metal contained in the internal electrode and the conductive particle contained in the conductive paste for an external electrode may be hindered, such that a defect in connectivity of the multilayer ceramic capacitor may be generated.

In the case of the conductive powder coated with glass according to the embodiment of the present invention, dispersibility of the glass may be improved, such that at the time of forming the external electrode, a formation of a pore in the electrode may be prevented, and compactness of the external electrode may be improved.

At the same time, the glass is asymmetrically coated, such that a decrease in capacitance due to connection defects that may be generated when the glass is uniformly coated may be prevented.

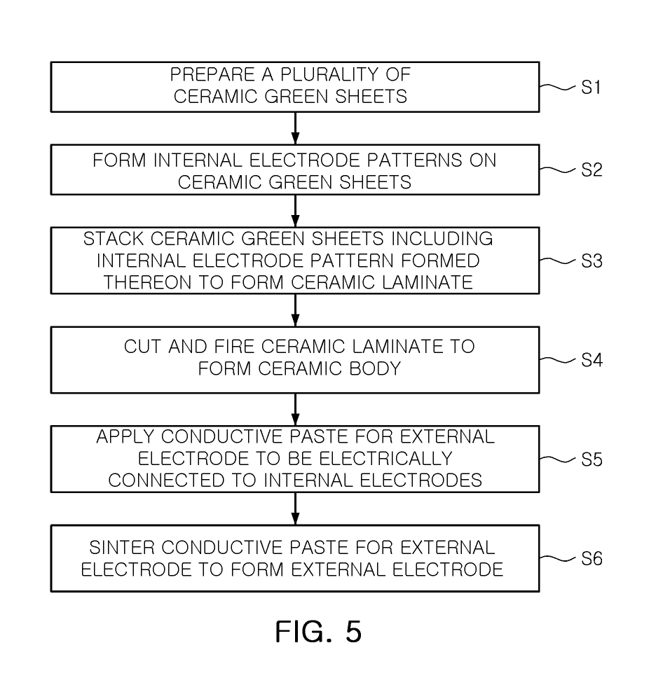

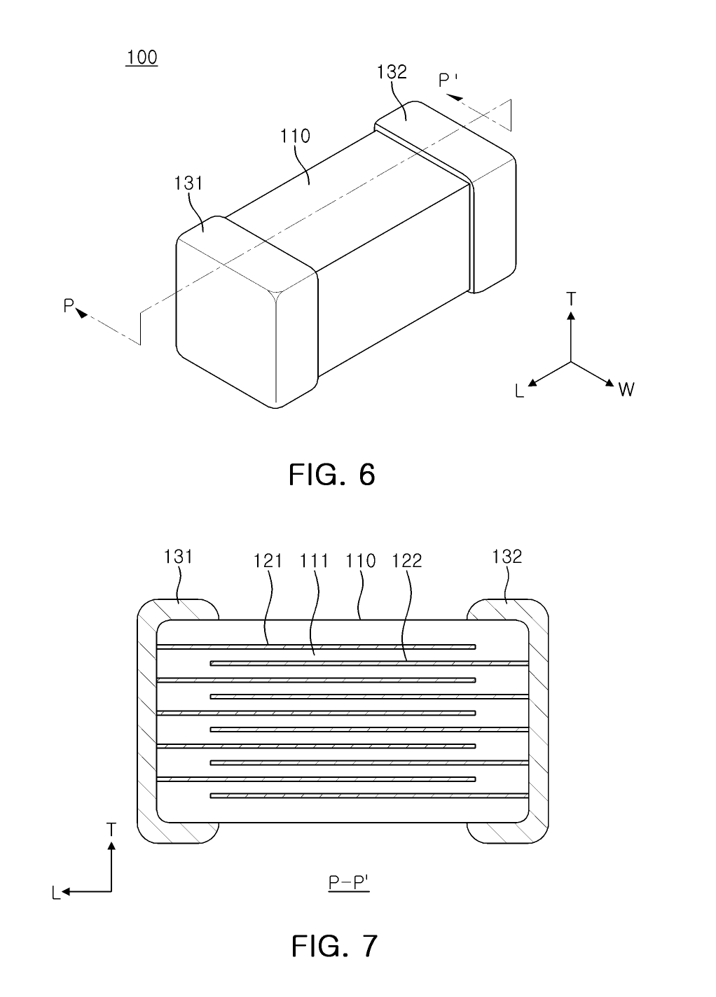

FIG. 5 is a flow chart showing a manufacturing method of a multilayer ceramic capacitor according to an embodiment of the present invention. FIG. 6 is a schematic perspective view of the multilayer ceramic capacitor manufactured according to the embodiment of the present invention.

FIG. 7 is a cross-sectional view of the multilayer ceramic capacitor, taken along line P-P′ of FIG. 6.

Referring to FIG. 5, a manufacturing method of a multilayer ceramic capacitor according to an embodiment of the present invention may include: preparing a plurality of ceramic green sheets (S1); forming internal electrode patterns on the ceramic green sheets (S2); stacking the ceramic green sheets including the internal electrode patterns formed thereon to form a ceramic laminate (S3); firing the ceramic laminate to form a ceramic body (S4); applying a conductive paste for an external electrode to be electrically connected to internal electrodes (S5); and sintering the conductive paste for an external electrode to form an external electrode (S6).

Hereinafter, the manufacturing method of a multilayer ceramic capacitor according to the embodiment of the present invention will be described with reference to FIGS. 5 through 7, but the present invention is not limited thereto.

In addition, in descriptions regarding the manufacturing method of a multilayer ceramic capacitor according to the embodiment of the present embodiment, a description overlapped with that of the above-mentioned multilayer ceramic capacitor will be omitted.

In the manufacturing method of a multilayer ceramic capacitor according to the embodiment of the present invention, a slurry containing a powder such as a barium titanate (BaTiO₃) powder, or the like, may be applied to carrier films and dried thereon to prepare the plurality of ceramic green sheets, thereby forming dielectric layers and cover layers.

The ceramic green sheets may be manufactured by mixing a ceramic powder, a binder, and a solvent, together, to prepare the slurry and forming the prepared slurry in sheet shapes each having a thickness of several μm by a doctor blade method.

Next, a conductive paste for an internal electrode containing a nickel powder may be prepared.

After the conductive paste for an internal electrode is applied to the respective green sheets by a screen printing method to form the internal electrodes, a plurality of ceramic green sheets having the internal electrodes printed thereon may be stacked to form a laminate and a plurality of ceramic green sheets having no internal electrodes printed thereon may be stacked on upper and lower surfaces of the laminate, and then the plurality of ceramic green sheets may be fired, thereby manufacturing the ceramic body 110. The ceramic body may include internal electrodes 121 and 122, dielectric layers 111, and the cover layers, wherein the dielectric layers may be formed by firing the green sheets having the internal electrodes printed thereon, and the cover layers may be formed by firing the green sheets having no internal electrodes printed thereon.

The internal electrodes may be formed as first and second internal electrodes.

Thereafter, surface polishing may be performed on the ceramic body by treating the ceramic body in a barrel containing water and a polishing medium.

The ceramic body 110 may include an active layer as a part thereof contributing to a formation of capacitance of the capacitor and upper and lower cover layers formed on upper and lower portions of the active layer as upper and lower margin parts. The active layer may include the dielectric layers 111 and the internal electrodes 121 and 122, wherein a plurality of the first and second internal electrodes 121 and 122 may be alternately formed, having the dielectric layers 111 therebetween.

In the embodiment of the present invention, a shape of the ceramic body 110 is not particularly limited, but may be substantially a hexahedral shape. A difference in thicknesses in the ceramic body 110 may be generated depending on a firing shrinkage of the ceramic powder at the time of firing a chip and the presence or absence of the internal electrode pattern, and a corner portion of the ceramic body may be polished, such that the ceramic body 110 does not have a complete hexahedral shape but may have a shape substantially similar to a hexahedral shape.

The internal electrodes may include the first and second internal electrodes 121 and 122, wherein the first and second internal electrodes may be disposed to face each other, having the dielectric layers 111 therebetween. The first and second internal electrodes 121 and 122, pairs of electrodes having different polarities, may be formed in a direction in which the dielectric layers 111 are stacked, so as to be alternately exposed to both end surfaces of the ceramic body 110, and may be electrically insulated from each other by the dielectric layers 111 disposed therebetween.

That is, the first and second internal electrodes 121 and 122 may be electrically connected to first and second external electrodes 131 and 132, to be formed later, through portions thereof alternately exposed to the both end surfaces of the ceramic body 110, respectively.

Therefore, when voltage is applied to the first and second external electrodes 131 and 132, electric charges are accumulated between the first and second internal electrodes 121 and 122 facing each other. In this case, capacitance of the multilayer ceramic capacitor 100 may be in proportion to an area of an overlapped region between the first and second internal electrodes 121 and 122.

A thickness of the first and second internal electrodes 121 and 122 as described above may be determined according to the use thereof. For example, the thickness of the first and second internal electrodes 121 and 122 may be determined to be in a range of 0.2 to 1.0 μm in consideration of a size of the ceramic body 110, but the present invention is not limited thereto.

Further, the conductive metal contained in the first and second internal electrodes 121 and 122 may be nickel (Ni), copper (Cu), palladium (Pd), or an alloy thereof, but the present invention is not limited thereto.

In this case, a thickness of the dielectric layers 111 may be optionally changed according to designed capacitance of the multilayer ceramic capacitor. Preferably, the thickness of each dielectric layer may be 0.1 to 10 μm after firing, but the present invention is not limited thereto.

Further, the dielectric layers 111 may include a ceramic powder having high permittivity, for example, a barium titanate (BaTiO₃) based powder or strontium titanate (SrTiO₃) based powder, or the like, but the present invention is not limited thereto.

The upper and lower cover layers may have the same material and configuration as those of the dielectric layers 111, except that the internal electrodes are not included therein. The upper and lower cover layers may be formed by stacking one or more dielectric layers on upper and lower surfaces of the active layer in a vertical direction, respectively, and generally serve to prevent the first and second internal electrodes 121 and 122 from being damaged by physical or chemical stress.

Next, the first and second external electrodes 131 and 132 may be formed to be electrically connected to the first and second internal electrodes, respectively, by applying the conductive paste for an external electrode onto external surfaces of the ceramic body and then sintering the applied conductive paste.

The conductive paste for an external electrode may include the composite conductive powder 10 according to the foregoing embodiment and further include a base resin, an organic vehicle, and other additives.

Particularly, the composite conductive powder 10 may include the conductive particle 1 and the coating layer 2 formed on the surface of the conductive particle 1 and including glass, and when the thickness of the coating layer in the portion A in which the coating layer is the thickest, on the surface of the conductive particle is defined as a, and the thickness of the coating layer in the portion B forming an angle of 90° with respect to the portion A on the surface of the conductive particle, based on the center of the conductive particle is defined as b, the coating layer may satisfy 0.1≦b/a≦0.7.

The base resin, the organic vehicle, and other additives are not particularly limited as long as they are generally used to prepare a conductive paste composition for an external electrode, and contents thereof may be variously changed according to objects of the present invention.

In the case in which a conductive paste for an external electrode includes a conductive power and a glass power according to the related art, coarse glass particles may be present in the paste (See FIG. 4), and a phase of the coarse glass particle is changed into a liquid phase during a firing process of the electrode and then moves to a particle boundary between the conductive particles, such that a space in which the glass particle has been disposed may remain as a large pore.

This pore is not completely removed even after the firing of the electrode has been finally terminated, thereby causing deterioration in compactness of the external electrode.

In order to solve such a deterioration in the compactness of the external electrode, sufficient diffusion of atoms through firing at a high temperature is required. However, in the case of firing the external electrode at a high temperature, conductive atoms in the external electrode diffuse into the internal electrode, but a volume thereof may be expanded, thereby causing a crack in the ceramic body.

In other words, in the case of sintering the external electrode, a phase of the glass in the conductive paste for an external electrode may be changed into a liquid phase, and the glass in the liquid phase may be distributed in the vicinity of conductive powder particles and serve to rearrange the conductive powder particles and to induce a liquid phase sintering between the conductive powder particles, thereby promoting a sintering process. In addition, the glass may fill voids between the conductive powder particles to increase the compactness of the external electrode after sintering.

In this case, when the coarse glass particles having non-uniform shapes are present in the external electrode, close packing of the conductive powder particles and glass particles may not be performed in the conductive paste for an external electrode, and porosity may be increased, thereby degrading the compactness of the external electrode. Further, when the coarse glass particles are present in the conductive paste for an external electrode, a local liquid sintering may be instantly generated only in the conductive powder particles in the vicinity of the coarse glass particles due to the phase of glass being changed into the liquid phase at a sintering temperature, which may hinder an implementation behavior of the compactness of the external electrode.

However, in the case in which the conductive paste for an external electrode does not include the conductive powder and the glass powder, separately, but includes the composite conductive powder formed by coating the surface of the conductive powder with the glass according to the embodiment of the present invention, the sintering may be performed at a higher rate as compared to the case of using a separate glass powder, and a dense external electrode may be implemented even at a low temperature.

Further, in the case of using a spherical conductive particle according to the embodiment of the present invention, movements of the glass contained in the coating layer may be facilitated, thereby further improving a degree of compactness.

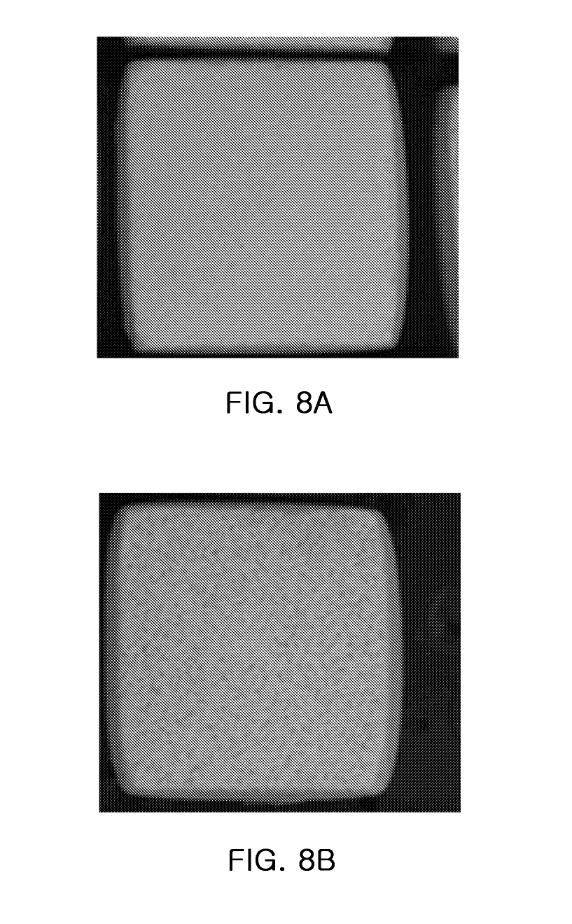

FIGS. 8A through 10B are photographs showing external electrodes of multilayer ceramic capacitors manufactured according to Example of the present invention and Comparative Example.

A case of forming an external electrode using a conductive paste for an external electrode including a conductive powder and a glass powder, separately, is defined as Comparative Example, and a case of forming an external electrode using the conductive paste for an external electrode including the composite conductive powder according to the embodiment of the present invention is defined as Example.

More specifically, FIG. 8A is a photograph showing a surface of an external electrode of the multilayer ceramic capacitor manufactured according to the embodiment of the present invention, and FIG. 8B is a photograph showing a surface of an external electrode of a multilayer ceramic capacitor according to Comparative Example.

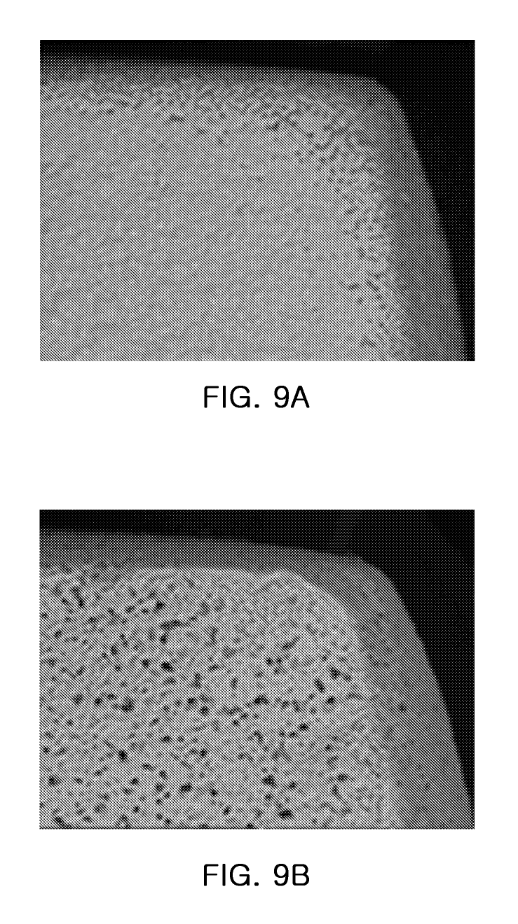

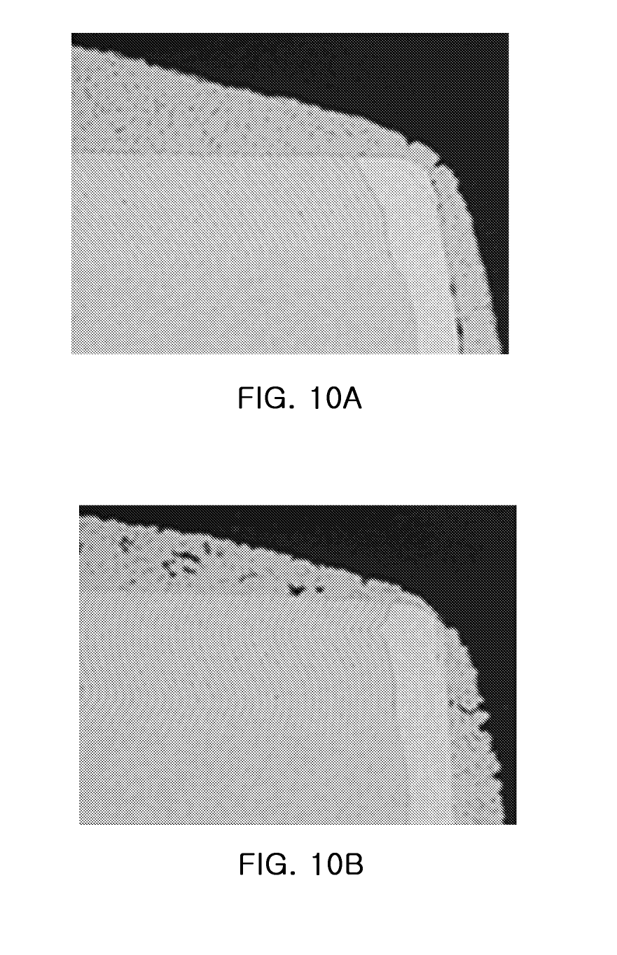

FIGS. 9A and 9B are photographs showing enlarged surfaces of the external electrodes of FIGS. 8A and 8B, respectively.

FIG. 10A is a photograph showing a cross-section of the external electrode of the multilayer ceramic capacitor manufactured according to the embodiment of the present invention, and FIG. 10B is a photograph showing a cross-section of the external electrode of the multilayer ceramic capacitor according to the Comparative Example.

As shown in FIGS. 8A, 9A, and 10A, it may be confirmed that in the case of forming the external electrode using the conductive paste for an external electrode including the composite conductive powder according to the embodiment of the present invention, an amount of porosity in the external electrode was significantly decreased, and the compactness of the external electrode was also improved.

Further, since the external electrode was densely formed at a temperature of 800° C. or greater in Comparative Example, in the case of densely forming the external electrode, cracks were generated in the ceramic body due to high-temperature sintering. However, since the compactness of the external electrode may be implemented at a low temperature of about 720° C. in Example of the present invention, cracks were rarely generated in the ceramic body.

Therefore, according to the present invention, the external electrode may be densely formed at a low temperature by using the composite conductive powder having a surface coated with the glass component at the time of manufacturing the conductive paste for an external electrode, applied to the multilayer ceramic capacitor, and a crack to be generated in the ceramic body may be suppressed by controlling the diffusion of the conductive particles contained in the external electrode into the ceramic body.

Further, deterioration in connectivity between the conductive particles due to the coating layer may be overcome by asymmetrically coating the glass, such that the multilayer ceramic capacitor of which capacitance is secured may be provided.

### Experimental Example

The following Table 1 show data obtained by testing whether connectivity between an internal electrode and an external electrode and a degree of compactness of the external electrode according to a thickness of a coating layer coated on a conductive particle included in a paste for an external electrode.

In detail, when a thickness of the coating layer in a portion A in which the coating layer is the thickest, on a surface of the conductive particle is defined as a, and a thickness of the coating layer in a portion B forming an angle of 90° with respect to the portion A on the surface of the conductive particle, based on the center of the conductive particle is defined as b, values of b/a was measured and the tests were performed.

TABLE 1

| Sample | b/a | Connectivity | Compactness |
|---|---|---|---|
| 1* | 0 | ◯ | X |
| 2* | 0.05 | ◯ | X |
| 3 | 0.1 | ◯ | ◯ |
| 4 | 0.2 | ◯ | ◯ |
| 5 | 0.3 | ◯ | ◯ |
| 6 | 0.4 | ◯ | ◯ |
| 7 | 0.5 | ◯ | ◯ |
| 8 | 0.6 | ◯ | ◯ |
| 9 | 0.7 | ◯ | ◯ |
| 10* | 0.8 | X | ◯ |
| 11* | 0.9 | X | ◯ |
| 12* | 1.0 | X | ◯ |

*Comparative Example
◯: Good connectivity and compactness.
X: 1% or more of defect ratio in connectivity and compactness.

As shown in Table 1, it may be confirmed that in the case in which b/a is greater than 0.7, the coating layer was entirely thick, such that bonding between the conductive particle in the composite conductive powder and the conductive material contained in the internal electrode was hardly generated, thereby causing a connectivity defect in which connectivity is not implemented, while in the case in which b/a is less than 0.1, a content of the coated glass is excessively low, such that dispersion in an absolute amount of the glass in the conductive paste for an external electrode was generated, thereby deteriorating the compactness of the external electrode.

Therefore, it may be appreciated that it is necessary to form the coating layer on the surface of the conductive particle so as to satisfy 0.1≦b/a≦0.7.

As set forth above, according to the embodiment of the present invention, the composite conductive powder capable of improving a degree of compactness of the external electrode and ensuring high capacitance while preventing the occurrence of cracks in the ceramic body, the conductive paste for an external electrode including the same, and the manufacturing method of a multilayer ceramic capacitor using the conductive paste for an external electrode can be provided.

While the present invention has been shown and described in connection with the embodiments, it will be apparent to those skilled in the art that modifications and variations can be made without departing from the spirit and scope of the invention as defined by the appended claims.

What is claimed is:

1. A composite conductive powder comprising:
a conductive particle; and
a coating layer formed on a surface of the conductive particle and including glass,
wherein when a thickness of the coating layer in a portion A in which the coating layer is the thickest, on the surface of the conductive particle is defined as a, and a thickness of the coating layer in a portion B forming an angle of 90° with respect to the portion A on the surface of the conductive particle, based on a center of the conductive particle is defined as b, 0.1≦b/a≦0.7 is satisfied.

2. The composite conductive powder of claim 1, wherein when a diameter of the conductive particle is defined as d, a/d<0.2 is satisfied.

3. The composite conductive powder of claim 1, wherein the thickness of the coating layer is gradually increased from a portion in which the coating layer is thinnest to the portion A in which the coating layer is the thickest, on the surface of the conductive particle.

4. The composite conductive powder of claim 1, wherein the glass is included in an amount of 1 to 20 parts by weight based on 100 parts by weight of the conductive particle.

5. The composite conductive powder of claim 1, wherein the glass has a density of 1.5 g/cc to 5.0 g/cc.

6. The composite conductive powder of claim 1, wherein the conductive particle has an average particle diameter of 0.5 to 2.0 μm.

7. The composite conductive powder of claim 1, wherein the conductive particle has a spherical shape.

8. A conductive paste for an external electrode, the conductive paste comprising:
a conductive particle; and
a coating layer formed on a surface of the conductive particle and including glass,
wherein when a thickness of the coating layer in a portion A in which the coating layer is the thickest, on the surface of the conductive particle is defined as a, and a thickness of the coating layer in a portion B forming an angle of 90° with respect to the portion A on the surface of the conductive particle, based on a center of the conductive particle is defined as b, 0.1≦b/a≦0.7 is satisfied.

9. A manufacturing method of a multilayer ceramic capacitor, the manufacturing method comprising:
preparing a plurality of ceramic green sheets;
forming internal electrode patterns on the ceramic green sheets;
stacking the ceramic green sheets including the internal electrode patterns formed thereon to form a ceramic laminate;
firing the ceramic laminate to form a ceramic body;
applying a conductive paste for an external electrode to be electrically connected to internal electrodes; and
sintering the conductive paste for an external electrode to form an external electrode,
wherein the conductive paste for an external electrode may include a conductive particle and a coating layer formed on a surface of the conductive particle and including glass, and when a thickness of the coating layer in a portion A in which the coating layer is the thickest, on the surface of the conductive particle is defined as a, and a thickness of the coating layer in a portion B forming an angle of 90° with respect to the portion A on the surface of the conductive particle, based on a center of the conductive particle is defined as b, 0.1≦b/a≦0.7 is satisfied.

10. The manufacturing method of claim 9, wherein the sintering of the conductive paste for an external electrode is performed at 600 to 800° C.

11. The manufacturing method of claim 9, wherein when a diameter of the conductive particle is defined as d, a/d<0.2 is satisfied.

12. The manufacturing method of claim 9, wherein the thickness of the coating layer is gradually increased from a portion in which the coating layer is thinnest to the portion A in which the coating layer is the thickest, on the surface of the conductive particle.

13. The manufacturing method of claim 9, wherein the glass is included in an amount of 1 to 20 parts by weight based on 100 parts by weight of the conductive particle.

14. The manufacturing method of claim 9, wherein the glass has a density of 1.5 g/cc to 5.0 g/cc.

15. The manufacturing method of claim 9, wherein the conductive particle has an average particle diameter of 0.5 to 2.0 μm.

16. The manufacturing method of claim 9, wherein the conductive particle has a spherical shape.
